(19) United States
(12) Patent Application Publication
(10) Pub. No.: US 2021/0399351 A1
(43) Pub. Date: Dec. 23, 2021

(54) METHOD FOR INVESTIGATING A CYLINDRICAL SHAPE OF A BATTERY

(71) Applicant: XAVIS CO., LTD., Seongnam-si (KR)

(72) Inventors: Hyeong-Cheol KIM, Seongnam-si (KR); Ki-Yeol EOM, Seongnam-si (KR); Yong-Han JANG, Seongnam-si (KR)

(21) Appl. No.: 16/909,199

(22) Filed: Jun. 23, 2020

(51) Int. Cl. H01M 10/42; G01N 23/04

(52) U.S. Cl. CPC H01M 10/4285; G01N 2223/1016; G01N 23/04

(57) ABSTRACT

Provided is a method for investigating a cylindrical shape of a battery. The method for investigating a battery with an x-ray image comprises determining a center line of an inspected battery; setting a ROI (Region of Interest) of each partial area formed on base of the center line and obtaining each x-ray image of each partial area; and combining each x-ray image and obtaining a total x-ray image of the battery, wherein the partial areas are formed according to a transferring speed of the battery.

### BACKGROUND OF THE INVENTION

### 1. Field of the Invention

The present invention relates to a method for investigating a cylindrical shape of a battery, in particular relates to the method for investigating the battery by dividing an area of the battery into a plural of parts to obtain an exact x-ray image.

### 2. Description of the Related Art

An investigating method with an x-ray image has an advantage that an inner part can be investigated, compared with an optical investigating method or the like. On the other hand, the x-ray investigating method has a problem that the x-ray image should be made within a shielded volume and a complex facility has to be equipped for obtaining an exact x-ray detecting image. The x-ray investigating method becomes a non-destructive inspection, and the demand for the x-ray inspection is increasing in an industrial field that an accurate inspection with a lower inspecting error is required and an inspected object should not be damaged in a course of the inspection. For example, various batteries such as a potable battery for a smart phone or a camera or a battery cell for an electrical vehicle may be investigated with the x-ray inspection. Korean Patent Registration No. 10-1133048 discloses an x-ray apparatus for investigating a battery, and Korean Patent Publication No. 10-2017-0016179 discloses an x-ray apparatus for investigating a cylindrical shape of a battery. For the inspection of the battery, a means for a suitable x-ray image of the battery need to be made according to the kind of the battery. But the known inventions did not suggest an advantageous means for obtaining an x-ray image for the cylindrical shape of a battery.

### PURPOSE OF THE INVENTION

An object of the present invention is to provide with a method for investigating a cylindrical shape of a battery in which an area of the battery is divided as a plural of parts based on an inspecting center line of the battery for investigating the total area of the battery.

### SUMMARY OF THE INVENTION

In one embodiment of the present invention, a method for investigating a battery with an x-ray image comprises determining a center line of an inspected battery; setting a ROI (Region of Interest) of each partial area formed on the basis of the center line and obtaining each x-ray image of each partial area; and combining each x-ray image and obtaining a total x-ray image of the battery, wherein the partial areas are formed according to a transferring speed of the battery.

In other embodiment of the present invention, a shape of the battery becomes a cylindrical form, and the partial areas are located at a lower part and an upper part of the battery.

In another embodiment of the present invention, the battery is transferred along a circle path centering an x-ray tube.

In still another embodiment of the present invention, the battery is transferred in a state of being loaded within a carrier.

### BRIEF DESCRIPTION OF THE DRAWINGS

FIG. 1 shows an exemplary embodiment of a method for investigating a battery according to the present invention.

FIG. 2 shows an exemplary embodiment of a process for investigating a cylindrical shape of a battery according to the present invention.

FIG. 3A and 3B show an exemplary embodiment of an x-ray apparatus to apply a method according to the present invention.

### DETAILED DESCRIPTION OF EXEMPLARY EMBODIMENTS

Exemplary embodiments of the present invention will be described herein below with reference to the accompanying drawings.

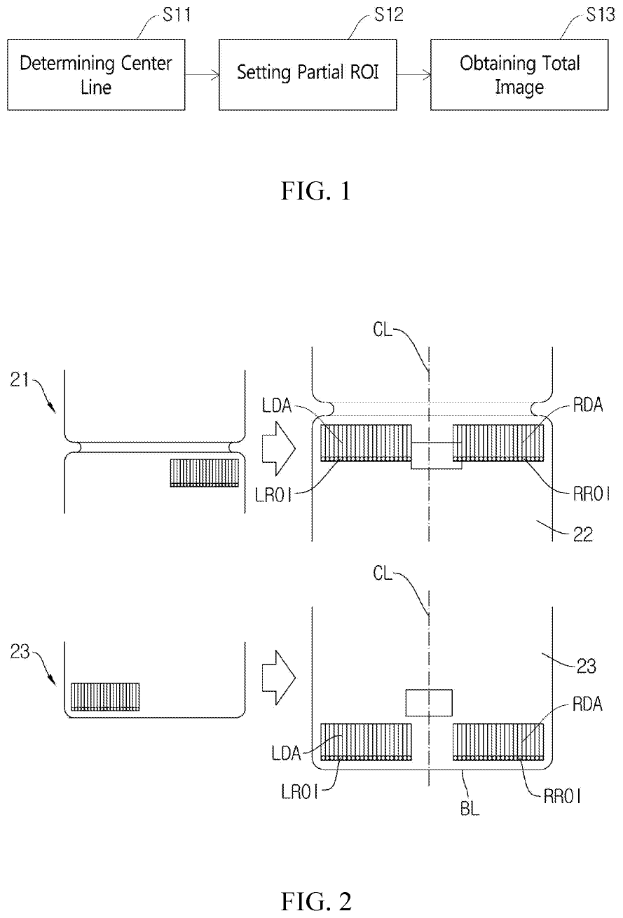

FIG. 1 shows an exemplary embodiment of a method for investigating a battery according to the present invention.

Referring to FIG. 1, the method for investigating a battery with an x-ray image comprises determining a center line of an inspected battery S11; setting a ROI (Region of Interest) of each partial area formed on the basis of the center line and obtaining each x-ray image of each partial area S12; and combining each x-ray image and obtaining a total x-ray image of the battery S13, wherein the partial areas are formed according to a transferring speed of the battery.

The battery to be investigated may have a cylindrical shape, but not limited to. A plurality of batteries may be transferred continuously, for example the plurality of batteries may be moved along a circular path to an investigating location by a rotary transferring means with a circular shape. An x-ray tube and a detector may be arranged at the investigating location, and an x-ray emitted from the x-ray tube may transmit the battery to be detected by the detector for obtaining an x-ray image of the battery. The cylindrical shape of the battery may have a jelly roll structure. A center line of the battery may be determined for obtaining the x-ray image S11. The center line may be a linear line to extend in a vertical direction to a battery transferring direction. The center line may be an imaginary line, and become a reference line of partial areas for obtaining each partial image. If the center line is determined S11, then the partial areas can be set or formed as a ROI (region of interest) based on the center line S12. And then each x-ray image of each partial area set as the ROI can be obtained S12. The x-ray image of each partial area can be obtained in course of transferring the battery, and each x-ray image may be obtained independently by each x-ray tube and detector in different locations. If all of the x-ray images of the partial areas set as the ROIs are obtained, then a total image of the battery may be obtained by combining all of the partial images S13. And a decision whether the battery has some defect or not can be made from the total x-ray image of the battery.

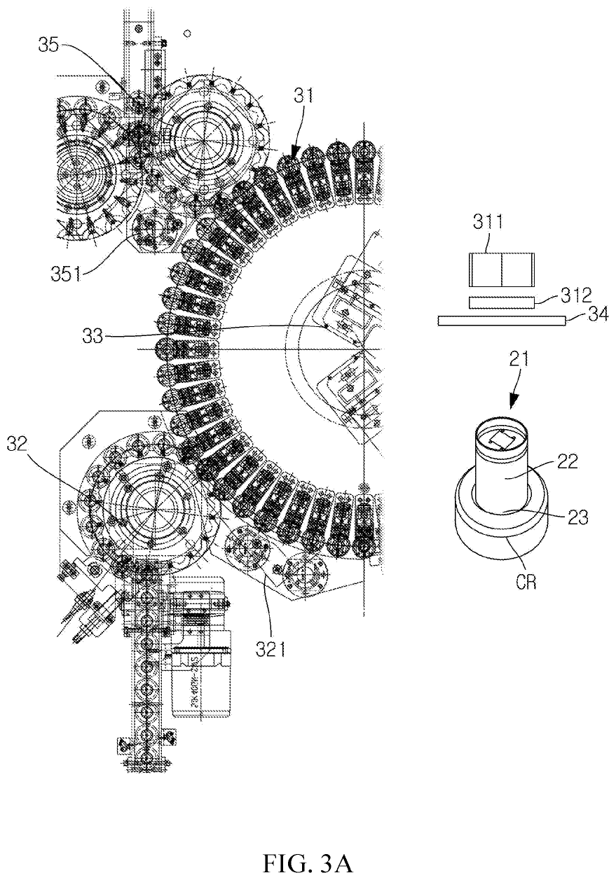

FIG. 2 shows an exemplary embodiment of a process for investigating a cylindrical shape of a battery according to the present invention.

Referring to FIG.2, the battery 21 to be inspected may have a cylindrical shape, for example the battery 21 may become a jelly roll battery. All surrounding area of the battery 21 may be set as an inspecting area 22, and a center line CL of the inspecting area 22 may be determined. The center line CL may be formed along a longitudinal direction of the cylindrical shape of the battery 21, and the center line CL may be a vertical to a direction of transferring of the battery 21. The inspecting area 22 may be divided into a left ROI LROI and a right ROI RLOI, and the inspecting area 22 may be divided into a left partial area LDA and a right partial area RDA. The ROI may be determined according to an inspecting factor of the battery 21. For example, a cathode roll and an anode roll may be the ROI in the battery 21 with the jelly roll structure. The cathode roll and the anode roll may be wound in a folding pattern to be made as a roll shape. And a position penetrating the cathode and the anode along a diameter may be determined as a ROI, for example, the dots designated successively along a horizontal direction in FIG.2 may be ROIs. And the center line CL may be a line vertical to a diameter passing a center. The left and right ROI LROI, RLOI may be set in the above manner, and the x-ray images may be obtained based on the left and right ROI LROI, RLOI to investigate whether the battery has some defect or not. Each x-ray image of each partial area LDA, RDA may be obtained to be compared each other for inspecting accurately. If the left and right ROI are set, an upper limiting area LU, RU to the inspecting factor may be set. The upper limiting area LU, RU may be a line connecting each inspecting factor or each upper end of the left and right ROI LROI, RROI, for example. Each upper limiting area LU, RU of the left and right ROI LROI, RROI based on the center line CL may be compared each other for investigating the battery 21. The inspecting factor may be determined in various ways, and a suitable ROI and upper limiting area may be set according to the inspecting factor. An upper inspecting area 22 and a lower inspecting area 23 of the battery are illustrated in the upper part and lower part in FIG.2.

The upper inspecting area 22 and the lower inspecting area 23 of the battery 21 may be investigated by different x-ray tubes, respectively. For example, each x-ray tube may be placed at different positions of the transferring path of the battery 21, and each x-ray image of the upper inspecting area 22 and the lower inspecting area 23 can be obtained by each x-ray tube. The investigation of the lower inspecting area 23 may be processed in same way as or in identical to that of the upper inspecting area 22. The center line CL of the lower inspecting area 23 may be formed at the same location or a different location compared to the center line of the upper inspecting area 22. And the left and right ROI LROI, RROI can be set at the left and right partial area LDA, RDA based on the center line CL. And also, a lower limiting area LL, RL may be set to the lower inspecting area 23. Each x-ray image related to the left and right partial area LDA, RDA may be obtained respectively, and some defect of the battery 21 may be detected, if exists. A lower border line BL may be set for investigating the lower inspecting area 23. The lower border line BL may be found by comparing a density difference between the battery 21 and a carrier receiving the battery 12. The battery 21 with the jelly roll structure may be investigated accurately by inspecting two partial areas divided with reference to the transferring direction of the cylindrical shape of the battery 21.

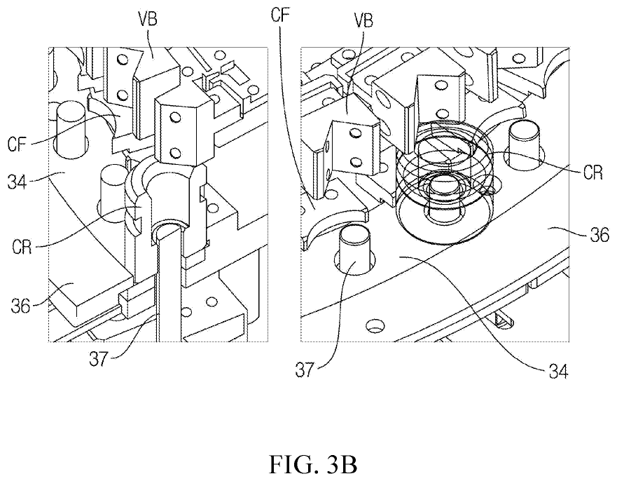

FIG. 3A and 3B show an exemplary embodiment of an x-ray apparatus to apply a method according to the present invention. 1191 Referring FIG. 3A, the battery 21 may be transferred along a circumference direction by a rotary transferring module 31, and the rotary transferring module 31 may comprise an upper fixing unit 311 for fixing the upper part of the battery 21 and a lower fixing unit 312 for fixing the lower part of the battery 21. The upper fixing unit 311 may become a shape of a circular ring, and a plurality of V-blocks for fixing the battery 21 may be distributed uniformly along a circular edge. Each battery 21 to be investigated may be fixed at each V-block. The battery 21 may be received into a carrier CR, and the lower part of the battery 21 may be received within the carrier CR. The carrier CR receiving the battery 21 may be fixed at the V-block of the rotary transferring module 31, and the carrier CR may be transferred along the circular path to arrive at an inspecting location where the x-ray tube is displaced. Each battery 21 may be received into each carrier CR, and may be transferred to the rotary transferring module 31 by an inputting unit 32. The battery 21 may be guided by a guiding unit 321 to be transferred to the inspecting location where an inspecting module 33 is displaced. A bottom surface of the carrier CR may contact a support unit 34 where the lower fixing unit 312 is fixed, and the battery 21 may be secured by contacting the V-block. If the battery 21 arrives at the inspecting location by rotation of the rotary transferring module 31, the inspection area of the battery 21 may be divided into two areas along the transferring direction. For example, the inspection area of the battery 21 which is secured at the V-block can be divided into two parts with reference to a center of the V-block. If each x-ray image to both parts of V-block securing the battery 21 is obtained, the battery 21 of which the inspecting process is completed may be transferred out of the investigating volume by being guided by an exit guide 351 through an exit unit 35. Two inspecting areas may be formed at the rotary transferring module 31, and the inspection for the upper inspecting area 22 and the lower inspecting area 23 of the battery 21 may be completed at each inspecting area. The battery 21 may be transferred by various transferring structures, not limited to the above example.

The battery 21 may be transferred in a state of be received into the carrier CL. If the carrier CL has not the battery 21, it is difficult for the vacant carrier CL to be transferred along the transferring path. When the battery is received into the carrier CL, the battery 21 can be secured at the V-block VB, the battery 21 can be transferred safely by the V-block VB having a magnetic property. Hence, the carrier CL where the lower part of the battery 23 is received can be transferred safely. But it is difficult for a vacant carrier CL to be secured at the rotary transferring module 31.

Referring to FIG. 3B, the carrier CR may be secured at a predetermined position by a circular protecting guide 36. A carrier fixing unit CF may be formed at a lower part of the V-block VB, and the fixing unit CR may be arranged along the V-block VB. When the battery 21 is transferred along the transferring path to the inspecting location in the state of being received into the carrier CR by the rotary transferring module 31, the upper part of the part may be secured at the V-block VB and the carrier CR may be secured at the carrier fixing unit CF. The carrier fixing unit CF may comprise a fixing part having a shape or the like corresponding to an outer circumference shape of the carrier. A vacant carrier CR can be secured at a predetermined location safely by the carrier fixing unit CF and the protecting guide 36. The protecting guide 36 may extend along a direction arranging the fixing unit CF or in a shape of circular ring. Selectively, a fixing member 37 capable of moving upward and downward may be installed at the supporting unit 34. A penetrating hole may be formed in an upward direction at the lower part of the carrier CR, and the fixing member 37 may have a shape to be inserted into the penetrating hole, for example, a shape of a rod with a circular section. When the carrier CR is guided to the rotary transferring module 31, the fixing member 37 may move upward to penetrate the penetrating hole for fixing the carrier CR to the predetermined position. When the carrier CR is removed from the rotary transferring module 31, the fixing member 37 may move downward for making the carrier CR be transferred outside the inspecting volume. The fixing member 37 may be arranged in condition of moving upward and downward at each outside of each V-block VB. And also, the fixing member 37 may be operated irrespective of whether the carrier CR has a battery 21 or not. The carrier CR can be fixed at the predetermined position of the rotary transferring module 31 in various ways for being transferred along the transferring path, not limited to.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method for investigating a battery with an x-ray image, comprising;
determining a center line of an inspected battery;
setting a ROI (Region of Interest) of each partial area formed on the basis of the center line and obtaining each x-ray image of each partial area; and
combining each x-ray image and obtaining a total x-ray image of the battery,
wherein the partial areas are formed according to a transferring speed of the battery.

2. The method according to claim 1, wherein a shape of the battery becomes a cylindrical form, and the partial areas are located at a lower part and a upper part of the battery.

3. The method according to claim 1, where the battery is transferred along a circle path centering an x-ray tube.

4. The method according the claim 1, wherein the battery is transferred in a state of being loaded within a carrier.
